(19) United States
(12) Patent Application Publication
(10) Pub. No.: US 2005/0212723 A1
(43) Pub. Date: Sep. 29, 2005

(54) Driving method of plasma display panel and plasma display device

(76) Inventors: Woo-Joon Chung, Suwon-si (KR); Jin-Sung Kim, Suwon-si (KR); Seung-Hun Chae, Suwon-si (KR)

Correspondence Address: CHRISTIE, PARKER & HALE, LLP, PO BOX 7068, PASADENA, CA, 91109-7068, US

(21) Appl. No.: 11/090,088

(22) Filed: Mar. 24, 2005

(30) Foreign Application Priority Data
Mar. 25, 2004 (KR) 10-2004-0020355

(51) Int. Cl. G09G 3/28

(52) U.S. Cl. 345/60

(57) ABSTRACT

A method for driving a plasma display panel including a plurality of scan electrodes, a plurality of sustain electrodes, and a plurality of address electrodes crossing the scan electrodes and the sustain electrodes. A voltage which is greater than a sustain-discharge pulse voltage and less than a voltage obtained by subtracting the sustain-discharge pulse voltage from two times a discharge firing voltage is applied to at least one of the scan electrodes in a reset period of at least one subfield of a plurality of subfields forming a field. At this time, the voltage applied to the at least one of the scan electrodes can be applied as a pulse-type voltage or as a gradually increasing voltage.

### CROSS REFERENCE TO RELATED APPLICATION

This application claims priority to and the benefit of Korean Patent Application No. 10-2004-0020355 filed on Mar. 25, 2004 in the Korean Intellectual Property Office, the entire content of which is incorporated by reference herein.

### BACKGROUND OF THE INVENTION

1. Field of the Invention

The present invention relates to a method for driving a plasma display panel (PDP).

2. Discussion of the Related Art

A PDP is a flat panel display for showing characters or images using plasma generated by gas discharge, and includes more than hundreds of thousands to millions of pixels in a matrix format, in which the number of pixels are determined by the size of the PDP. A configuration of a conventional plasma display panel will be described with reference to FIG. 1 and FIG. 2.

FIG. 1 shows a partial perspective view of a plasma display panel, and FIG. 2 shows an electrode arrangement of the plasma display panel.

As shown in FIG. 1, the plasma display panel includes two glass substrates 1 and 6. Pairs of a scan electrode 4 and a sustain electrode 5 are formed in parallel on a first glass substrate 1, and covered with a dielectric layer 2 and a protection film 3. A plurality of address electrodes 8 are formed on a second glass substrate 6, and the address electrodes 8 are covered with an insulator layer 7. Barrier ribs 9 are formed in parallel with the address electrode 8 on the insulator layer 7 between the address electrodes 8, and phosphors 10 are formed on the surface of the insulator layer 7 and on both sides of the barrier ribs 9. The glass substrates 1 and 6 are provided to face each other with discharge spaces 11 between the glass substrates 1 and 6 so that the scan electrodes 4 and the sustain electrodes 5 may respectively cross the address electrodes 8. A discharge space 11 between an address electrode 8 and a crossing part of a pair of a scan electrode 4 and a sustain electrode 5 forms a discharge cell 12.

As shown in FIG. 2, the electrodes of the plasma display panel have an m x n matrix format. The address electrodes A1 to Am are arranged in the column direction and n scan electrodes Y1 to Yn and sustain electrodes X1 to Xn are arranged in the row direction.

U.S. Pat. No. 6,294,875 by Kurata et al. discloses a method for driving a conventional plasma display panel. In the method, a field is divided into eight subfields, and a waveform applied in the reset period of a first subfield is established to be different from waveforms applied in the reset periods of second through eighth subfields.

As shown in FIG. 3, each subfield has a reset period, an address period, and a sustain period. In the reset period of the first subfield, a ramp voltage gradually rising from a voltage of Vp which is less than a discharge firing voltage to a voltage of Vr which is greater than the discharge firing voltage is applied to the scan electrodes Y1 to Yn. While the ramp voltage is increased, a weak discharge is respectively generated from the scan electrodes Y1 to Yn to the address electrodes A1 to Am and the sustain electrodes X1 to Xn. Negative wall charges are accumulated on the scan electrodes Y1 to Yn, and positive wall charges are accumulated on the address electrodes A1 to Am and the sustain electrodes X1 to Xn by the discharge. Since the dielectric layer 2 and the protection film 3 cover the scan electrode 4 and the sustain electrode 5 as shown in FIG. 1, the wall charges are formed on a surface of the protection film 3 covering the scan electrode 4 and the sustain electrode 5. However, it will be described, for the convenience of description, as though the wall charges are formed on the scan electrode 4 and the sustain electrode 5.

A ramp voltage gradually falling from a voltage of Vq which is less than the discharge firing voltage to 0V is applied to the scan electrodes Y1 to Yn. While the ramp voltage is reduced, a weak discharge is generated from the sustain electrodes X1 to Xn and the address electrodes A1 to Am to the scan electrodes Y1 to Yn by a wall voltage formed in the discharge cell. Some of the wall charges formed on the sustain electrodes X1 to Xn and the scan electrodes Y1 to Yn are substantially eliminated by the discharge, and therefore a proper or suitable state for an address operation is provided. Since the insulator layer 7 covers the address electrode 8 as shown in FIG. 1, the wall charges are formed on a surface of the insulator layer 7 covering the address electrode 8. However, it will be described, for the convenience of description, as though the wall charges are formed on the address electrode 8.

A positive voltage of Vw is applied to the address electrodes A1 to Am, and 0V is applied to the scan electrodes Y1 to Yn of the discharge cell to be selected in the address period. An address discharge is generated between the address electrodes A1 to Am and the scan electrodes Y1 to Yn, and between the sustain electrodes X1 to Xn and the scan electrodes Y1 to Yn by the positive voltage of Vw and the wall voltage caused by the wall charges formed in the reset period. The positive wall charges are accumulated on the scan electrodes Y1 to Yn, and the negative wall charges are accumulated on the sustain electrodes X1 to Xn and the address electrodes A1 to Am by the discharge. A sustain discharge is generated by a sustain pulse applied in the sustain period of the discharge cell having the wall charges accumulated by the address discharge.

A voltage level of a last sustain pulse applied to the scan electrodes Y1 to Yn in the sustain period of the first subfield corresponds to a voltage of Vr of the reset period, and a voltage of (Vr-Vs) corresponding to a difference between the voltage of Vr and a sustain voltage Vs is applied to the sustain electrodes X1 to Xn. A discharge is generated from the scan electrodes Y1 to Yn to the address electrodes A1 to Am, and the sustain discharge is generated from the scan electrodes Y1 to Yn to the sustain electrodes X1 to Xn in the discharge cell selected in the address period by the wall voltage formed by the address discharge. The discharge corresponds to the discharge generated by a rising ramp voltage in the reset period of the first subfield. No discharge is generated in the discharge cell which is not selected because no address discharge has been generated.

In a reset period of a second subfield, a voltage of Vh is applied to the sustain electrodes X1 to Xn, and a ramp voltage gradually falling from the voltage of Vq to 0V is applied to the scan electrodes Y1 to Yn. That is, a voltage corresponding to the falling ramp voltage applied in the reset period of the first subfield is applied to the scan electrodes Y1 to Yn. A weak discharge is generated in the selected discharge cell and no discharge is generated in the discharge cell which was not selected in the first subfield.

In reset periods of the other subfields, a waveform corresponding to the waveform in the reset period of the second subfield is applied. In an eighth subfield, an erasing period is formed after a sustain period. In the erasing period, a ramp voltage gradually rising from 0V to a voltage of Ve is applied to the sustain electrodes X1 to Xn. The wall charges formed in the discharge cell are substantially eliminated by the ramp voltage.

In the conventional driving waveform, a reset discharge is performed in the reset period for a cell that performed a sustain discharge in a previous subfield, after the first subfield. However, a wall charge loss is frequently generated by crosstalk caused by discharges of neighboring cells and a spontaneous extinction of the wall charges by an internal field in the cell where no sustain discharge is generated after the reset period. It is impossible to rearrange the wall charges by the reset waveform from the second subfield of the conventional manner as described above, and therefore an address operation is not properly performed in the address period. Also, when the reset waveform of the first subfield shown in FIG. 3 is applied, brightness quality gets worse and time for a reset operation is increased.

### SUMMARY OF THE INVENTION

In exemplary embodiments of the present invention, is provided a driving method of a plasma display panel for generating a reset-discharge by a reset waveform in sustain-discharged cells and cells having damaged wall charges as well as for the purpose of preventing an erroneous address discharge.

Additional features of the invention will be set forth in the description which follows, and in part will be apparent from the description, or may be learned by practice of the invention.

In an exemplary embodiment according to the present invention, is provided a method for driving a plasma display panel (PDP) including a plurality of first electrodes and a plurality of second electrodes formed on a first substrate, and a plurality of third electrodes crossing the first electrodes and the second electrodes and formed on a second substrate. Discharge cells are formed by the first, second, and third electrodes.

In the method, a voltage difference between voltages applied to at least one of the second electrodes and at least one of the first electrodes is increased from a first voltage to a second voltage, and is reduced, in a reset period of at least one of subfields.

A third voltage, which is less than the second voltage, is applied between the at least one of the second electrodes and the at least one of the first electrodes, and a voltage applied to the at least one of the second electrodes is gradually reduced from a fourth voltage to a fifth voltage, in a reset period of at least another one of the subfields.

The third voltage is greater than a sixth voltage corresponding to a voltage difference between voltages applied to the at least one of the first electrodes and the at least one of the second electrodes in a sustain period. At this time, the third voltage may be less than a voltage obtained by subtracting the sixth voltage from two times a discharge firing voltage.

In another exemplary embodiment according to the present invention, is provided a method for driving a plasma display panel including a plurality of first electrodes and a plurality of second electrodes formed on a first substrate, and a plurality of third electrodes crossing the first electrodes and the second electrodes and formed on a second substrate. Discharge cells are formed by the first, second, and third electrodes.

In the method, a field is divided into a plurality of subfields to be driven, and each subfield has a reset period, an address period, and a sustain period.

A voltage for a reset discharge is applied to at least one of the first electrodes and at least one of the second electrodes to perform a reset operation in the reset period.

A voltage for an address discharge is applied to the at least one of the first electrodes and the at least one of the third electrodes of at least one discharge cell selected from the discharge cells to perform an address operation in the address period.

A voltage for a sustain discharge is applied to the at least one of the first electrodes and the at least one of the second electrodes to perform a sustain operation in the sustain period.

In at least one subfield of the plurality of subfields, the reset operation performs a reset-discharge for discharge cells which were sustain-discharged and some discharge cells which were not sustain-discharged in a previous one of the plurality of subfields.

In yet another exemplary embodiment of the present invention, is provided a plasma display including a first substrate, a plurality of first electrodes, and a plurality of second electrodes formed on the first substrate in parallel, a second substrate facing the first substrate with a gap therebetween, a plurality of third electrodes formed on the second substrate and crossing the first electrodes and the second electrodes, and a driving circuit for supplying a driving voltage to the first electrodes, the second electrodes, and the third electrodes to discharge the discharge cells formed by the first, second, and third electrodes.

The driving circuit increases a voltage difference between voltages applied to at least one of the second electrodes and at least one of the first electrodes from a first voltage to a second voltage and reduces the voltage difference in a reset period of at least one of subfields, and applies a third voltage, which is less than the second voltage, between the at least one of the second electrodes and the at least one of the first electrodes, and reduces a voltage applied to the at least one of the second electrodes in a reset period of at least another one of the subfields.

The third voltage is greater than a fourth voltage which is a difference between voltages applied to the at least one of the first electrodes and the at least one of the second electrodes in a sustain period.

In yet another exemplary embodiment according to the present invention, is provided a method for driving a plasma display panel comprising a plurality of address electrodes, a plurality of scan electrodes and a plurality of sustain electrodes, during a field comprising a plurality of subfields, each of the subfields comprising a reset period, an address period and a sustain period. A voltage which is gradually increased from a first voltage to a second voltage is applied between at least one of the scan electrodes and at least one of the sustain electrodes during the reset period of at least one of the plurality of subfields. A third voltage is applied between the at least one of the scan electrodes and the at least one of the sustain electrodes during the reset period of at least another one of the subfields. The third voltage is lower than the second voltage and higher than a sustain voltage applied between the at least one of the scan electrodes and the at least one of the sustain electrodes during the sustain period. A voltage applied to the at least one of the scan electrodes is gradually reduced from the third voltage or a fourth voltage, which is lower than the third voltage, to a fifth voltage during the reset period of the at least another one of the subfields

### BRIEF DESCRIPTION OF THE DRAWINGS

The accompanying drawings, together with the specification, illustrate exemplary embodiments of the present invention, and, together with the description, serve to explain the principles of the present invention.

FIG. 1 shows a partial perspective view of a conventional plasma display panel (PDP).

FIG. 2 shows an electrode arrangement of a conventional PDP.

FIG. 3 shows driving waveforms of a conventional PDP.

FIG. 4 shows driving waveforms of a PDP according to a first exemplary embodiment of the present invention.

FIG. 5 shows driving waveforms of a PDP according to a second exemplary embodiment of the present invention.

FIG. 6 shows driving waveforms of a PDP according to a third exemplary embodiment of the present invention.

FIG. 7 shows driving waveforms of a PDP according to a fourth exemplary embodiment of the present invention.

FIG. 8 is a schematic block diagram of a plasma display that can be used to implement exemplary embodiments of the present invention.

### DETAILED DESCRIPTION

In the following detailed description, only certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive.

There may be parts shown in the drawings, or parts not shown in the drawings, that are not discussed in the specification as they are not essential to a complete understanding of the invention. Like reference numerals designate like elements.

Exemplary embodiments of the present invention will now be described in detail with reference to the drawings.

A method for driving a plasma display panel according to a first exemplary embodiment of the present invention will be described with reference to FIG. 4. In the following description, when address electrodes, scan electrodes, and sustain electrodes are respectively denoted by A1 to Am, Y1 to Yn, and X1 to Xn, a voltage is applied to the address electrodes, scan electrodes, and the sustain electrodes. Further, when the address electrodes and the scan electrodes are respectively denoted by Ai and Yi, a corresponding voltage is applied to some of the address electrodes and the scan electrodes.

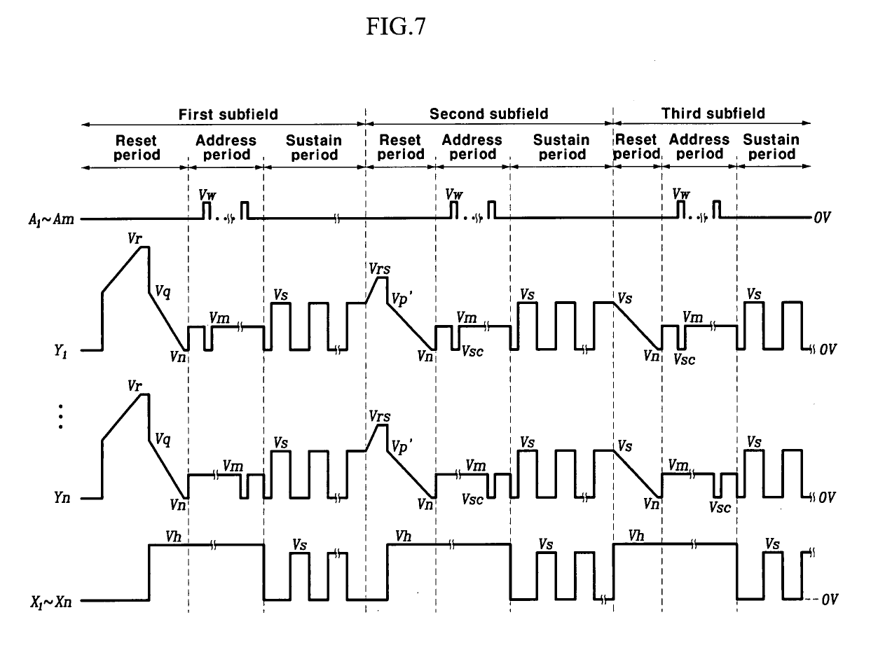

As shown in FIG. 4, a waveform according to the first exemplary embodiment of the present invention has a reset period, an address period, and a sustain period. In a plasma display, a scan/sustain driving circuit (illustrated in FIG. 7) for applying driving voltages to the sustain electrodes Y1 to Yn and the sustain electrodes X1 to Xn, and an address driving circuit (illustrated in FIG. 7) for applying a driving voltage to the address electrodes A1 to An, are coupled to the plasma display panel. The driving circuits and the plasma display panel are coupled to each other to thus make the plasma display.

Wall charges formed in the previous sustain period are substantially eliminated in the reset period, discharge cells to be displayed among the discharge cells are selected in the address period, and the discharge cells selected in the address period are discharged in the sustain period.

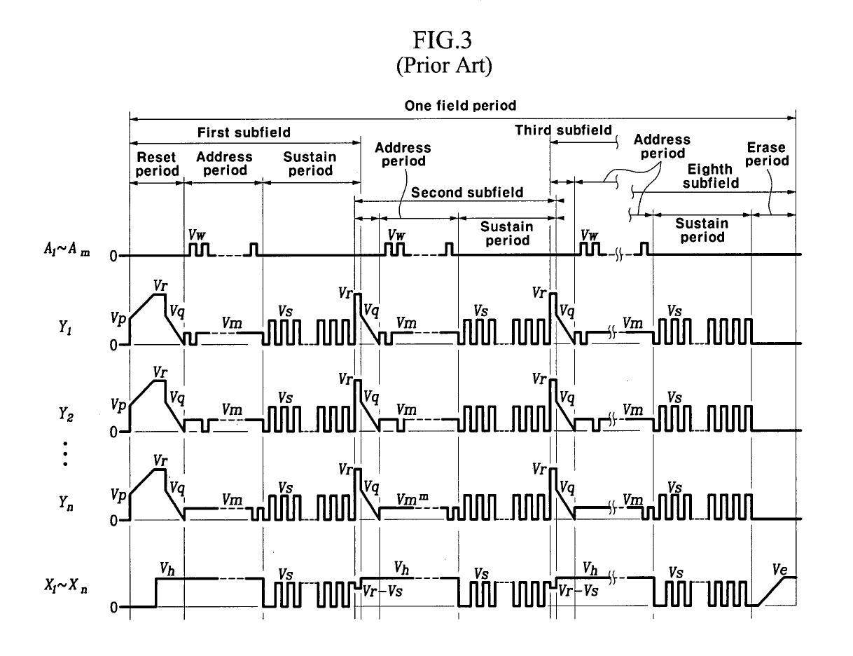

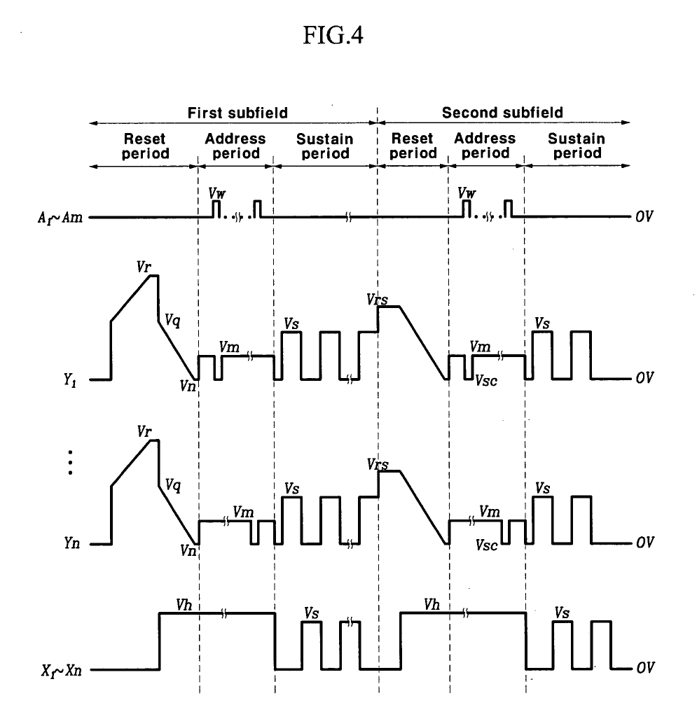

In the driving waveform according to the first exemplary embodiment of the present invention shown in FIG. 4, the waveform applied in the reset period of a first subfield is established to be different from the waveforms applied in the reset periods of one or more of second through eighth subfields, similar to the conventional waveforms shown in FIG. 3. Further, the waveform applied in the reset period of at least one subfield among the second through eighth subfields according to the first exemplary embodiment can be different from the waveforms applied during the reset periods of other ones of the second through eighth subfields. It should be noted that the first and second subfields of FIGS. 4-6 do not overlap in the illustrated embodiment. While FIGS. 4-6 show only first and second subfields, those skilled in the art would recognize that there may be other subfields (e.g., a total of 8 including the first and second subfields shown in FIGS. 4-6) of a field that are not illustrated in FIGS. 4-6. Further, the additional subfields in the exemplary embodiments of the present invention may not overlap with each other. Two or more subfields may partially overlap in other embodiments. To prevent any redundancy of description and/or illustration, the waveforms of other subfields that are substantially the same as the waveforms in the first and second subfields of FIGS. 4-6, respectively, are not illustrated in FIGS. 4-6, and will not be described.

In the sustain period, a sustain-discharge is generated by a difference between a wall voltage caused by wall charges formed by the discharge cell selected in the address period and a voltage formed by sustain pulses applied to the scan electrode and the sustain electrode. A voltage of Vs is applied to the scan electrodes Y1 to Yn and a reference voltage (in FIGS. 4-6, assumed to be 0V but could be other suitable voltage) is applied to the sustain electrodes X1 to Xn in the last sustain pulse of the sustain period. A discharge is generated from the sustain electrode Yi to the sustain electrode Xi, and negative wall charges and positive wall charges are respectively formed on the scan electrode Yi and the sustain electrode Xi in the selected discharge cell.

During the reset period of the second subfield, a voltage of Vrs which is less than the voltage of Vr applied in the reset period of the first subfield and greater than the sustain voltage Vs is applied to the scan electrodes Y1 to Yn. At this time, the voltage of Vrs applied to the scan electrodes Y1 to Yn has a sufficiently large value such that a reset operation is effectively performed in a cell having damaged wall charges from various reasons and/or a cell which performed sustain-discharge during the sustain period of a previous subfield, and has a sufficiently small value such that no reset operation is performed in a cell where the wall charges are not damaged and sustain-discharge was not performed during the previous subfield. The wall charges are substantially eliminated when cross-talk occurs between a cell which is not discharged in the sustain period and a neighboring cell which is discharged, and the wall charges of a cell addressed in the address period are substantially eliminated. A proper or suitable value of the voltage of Vrs is now described.

The wall voltage caused by the wall charges formed after the reset period of the first subfield is less than a difference between a voltage of Vf and the voltage of Vs (Vf-Vs) (herein, the voltage of Vf is referred to as a discharge firing voltage) because the sustain-discharge is generated in the sustain period of a cell which is not addressed in the address period when the wall voltage formed after the reset period is greater than a voltage of (Vf-Vs). Here, the discharge firing voltage Vf is the smallest sustain voltage at which a sustain discharge sequence spontaneously starts in a discharge cell as those skilled in the art would know. Accordingly, a maximum wall voltage of the cell where the wall charges are not damaged without being addressed in the address period is less than the voltage of (Vf-Vs), and the maximum wall voltage is less than the voltage of the discharge firing voltage Vf in order to not generate a discharge when the voltage of Vrs is applied in the cell where the wall charges are not damaged (that is, a sum of the Vrs and the voltage of (Vf-Vs)), which will be represented in Equation 1.
Vᵣₛ−(V_{f}−Vₛ)<V_{f} [Equation 1]

In Equation 1, the voltage of Vrs is subtracted by the voltage of (Vf-Vs) because the negative wall charges are formed on the scan electrodes Y1 to Yn after the reset period of the first subfield and the positive voltage is applied to the scan electrodes Y1 to Yn in the reset period of the second subfield. Equation 1 is rearranged as Equation 2.
Vᵣₛ<2V_{f}−Vₛ [Equation 2]

In Equation 2, the voltage of Vrs is established to be greater than the voltage of Vs as a minimum for the purpose of discharging the cell where the wall charges are damaged. Accordingly, a proper or suitable voltage of Vrs is given in Equation 3.
Vₛ<Vᵣₛ<2V_{f}−Vₛ [Equation 3]

That is, Equation 3 is satisfied with a proper value of Vrs which allows the discharge to be generated by applying the voltage of Vrs in the cell having the damaged wall charges, and allows the discharge to not be generated by applying the voltage of Vrs in the cell where the wall charges are not damaged.

A ramp voltage gradually falling from the voltage of Vrs to 0V (or another suitable voltage) is applied in the reset period. At this time, a voltage of Vh is applied to the sustain electrodes X1 to Xn, and a weak discharge is generated from the sustain electrodes X1 to Xn and the address electrodes A1 to Am to the scan electrodes Y1 to Yn by the wall voltage formed in a discharge cell because the discharge has been generated by applying the voltage of Vrs in the cell having the damaged wall charges when the ramp voltage gradually falling from the voltage of Vrs to 0V is applied. Accordingly, the cell having the damaged wall charges is prevented from discharge misfiring when the address operation is performed in the address period. No discharge is generated by applying the gradually falling ramp voltage because the discharge is not generated by applying the voltage of Vrs in the cell where the wall charges are not damaged and a discharge was not generated in the sustain period of the first subfield.

Also, no discharge is generated by applying the voltage of Vrs in the reset period of the second subfield (because the negative wall charges are formed in the scan electrode Yi by the sustain discharge), and a weak discharge is generated by applying the gradually falling ramp voltage in the cell where the discharge is generated in the sustain period of the first subfield. That is, the weak discharge is generated in the discharge cell selected in the first subfield, and therefore a configuration of the wall charge that causes a proper address operation in the address period is formed.

A reset discharge, the weak discharge, is generated by applying the reset waveform as that of the second subfield in the cell having the wall charges damaged for various reasons and the discharge cell selected in the first subfield, and therefore a problem of misfiring discharge in the address period is solved.

As shown in FIG. 4, the waveform in the address period and the waveform in the sustain period of the second subfield are substantially the same as the corresponding waveforms of the conventional waveform shown in FIG. 3, and therefore a detailed description will be omitted.

At least one waveform as the reset waveform of the second subfield is provided in a plurality of subfields, forming a field. The waveform can also be applied to other one or more subfields.

A strong discharge is generated when the voltage of Vrs is applied to the scan electrodes Y1 to Yn in the reset period of the second subfield as described in the first exemplary embodiment of the present invention, and therefore a reset operation may not be properly performed. A method for solving the problem associated with the strong discharge will now be described.

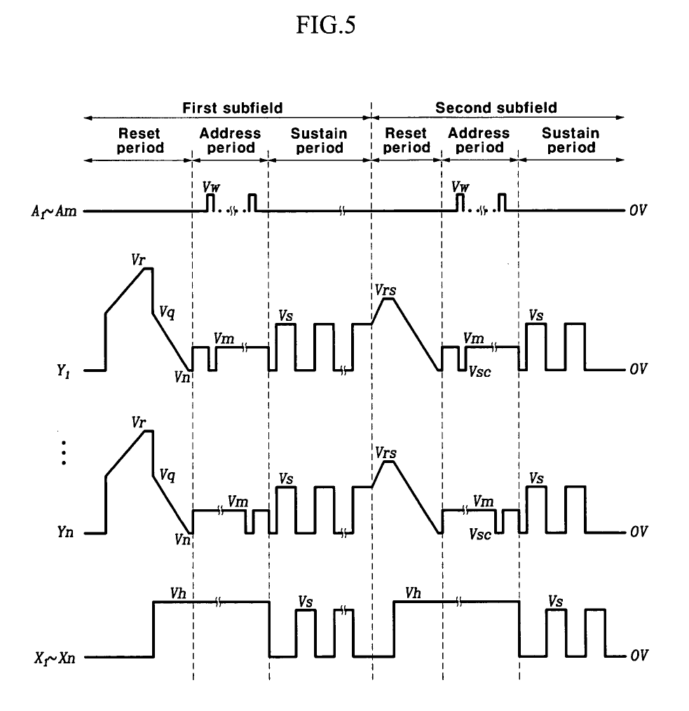

As shown in FIG. 5, a driving waveform according to a second exemplary embodiment of the present invention corresponds to that of the first exemplary embodiment of the present invention except that the voltage of Vrs is not directly applied but a ramp voltage gradually rising from the voltage of Vs to the voltage of Vrs is applied to the scan electrodes Y1 to Yn when the voltage of Vrs is applied in the reset period of the second subfield. The slope of the ramp voltage may be less than, or greater than or equal to, the slope in the reset waveform of the first subfield, by which the voltage applied to the scan electrodes Y1 to Yn rises to the voltage of Vr. The strong discharge caused in the first exemplary embodiment of the present invention is not generated by applying the gradually rising ramp voltage. At this time, the value of the voltage of Vrs satisfies Equation 3 as shown in the first exemplary embodiment.

While a gradually rising voltage is applied in FIG. 5 as the ramp voltage, the problem of the strong discharge is solved by a waveform gradually rising by RC resonance, a waveform gradually rising by floating, and/or a terraced waveform gradually rising.

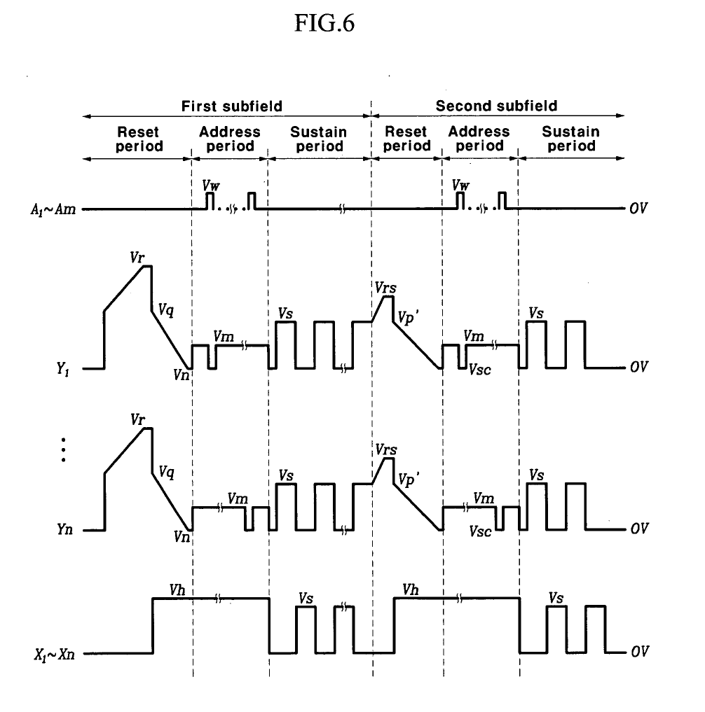

In the first and the second exemplary embodiments, the voltage gradually falling from the voltage of Vrs to 0V (or another suitable voltage) is applied in the reset period of the second subfield. However, the reset period is problematically increased when the voltage is gradually reduced from the voltage of Vrs to 0V. A method for solving the problem of the increase of the reset period will be shown in FIG. 6.

As shown in FIG. 6, a driving waveform according to a third exemplary embodiment of the present invention corresponds to that of the second exemplary embodiment of the present invention except that the ramp voltage gradually falling from the voltage of Vrs to 0V is not applied but a ramp voltage gradually falling from a voltage of Vp′ to 0V is applied to the scan electrodes Y1 to Yn in the reset period of the second subfield. At this time, the voltage of Vp′ is less than the voltage of Vrs, and therefore the reset period is further reduced because time for the ramp voltage reaching 0V is reduced. The wall charges are properly substantially eliminated in the reset period by applying the ramp voltage gradually falling to 0V from the voltage of Vp′ which is less than the voltage of Vrs.

FIG. 7 illustrates driving waveforms for first, second and third subfields of a fourth exemplary embodiment. The driving waveforms during the reset period for the first and second subfields are substantially the same as the driving waveforms during the reset period for the first and second subfields of FIG. 6. In the driving waveform for the third subfield, however, a ramp voltage gradually falling from a sustain voltage Vs to 0V is applied to the scan electrodes Y1 to Yn in the reset period.

While FIG. 7 shows the driving waveform (including the reset waveform applied during the reset period) for the third subfield applied after the first and second subfield waveforms of FIG. 6, a driving waveform having such a reset waveform can also be applied after the first and second subfield waveforms of FIGS. 4 and 5 as a respective third subfield waveform. Further, a waveform having the third subfield reset waveform (i.e., the waveform during the reset period of the third subfield) of FIG. 7 can be applied between the first subfield waveform and the second subfield waveform of any of FIGS. 4, 5 and 6. In such instances, the third subfield waveform of FIG. 7 would replace the second subfield waveforms of FIGS. 4, 5 and 6, respectively, as the waveform used during the second subfield, and the second subfield waveforms of FIGS. 4, 5 and 6 may then be applied as third subfield waveforms, respectively.

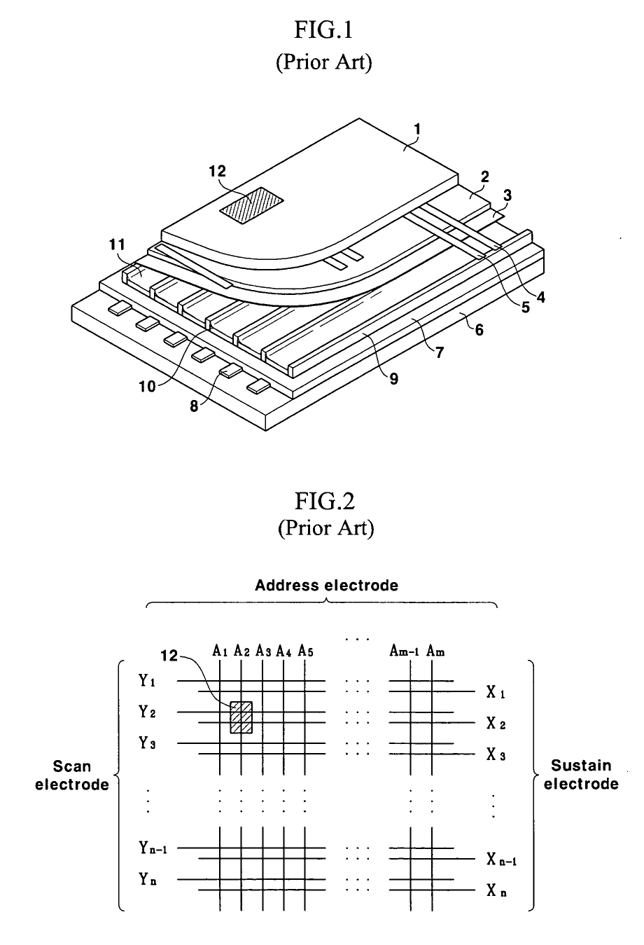

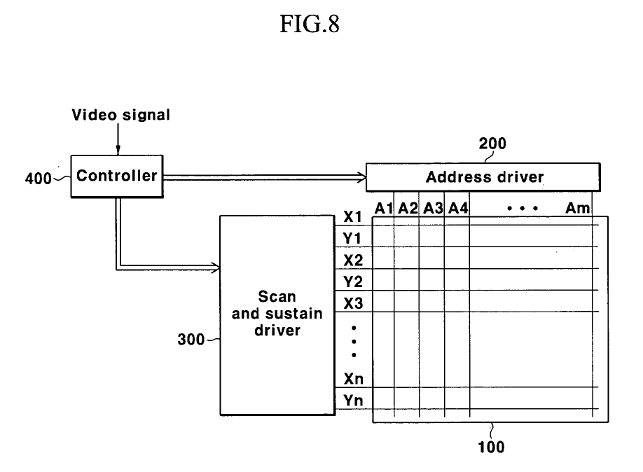

A plasma display of FIG. 8 includes a plasma display panel 100, an address driver 200, a scan/sustain driver 300, and a controller 400. The plasma display panel 100 includes address electrodes A1 to Am, sustain electrodes X1 to Xn and scan electrodes Y1 to Yn. The plasma display panel 100 may, for example, have substantially the same configuration as the plasma display panel of FIG. 1. The address driver 200 and the scan/sustain driver 300 can be referred to together as a driving circuit. The controller 400 receives a video signal and provides corresponding control signals to the address driver 200 and the scan/sustain driver 300. The address driver 200 and the scan/sustain driver 300 supply a driving voltage to the address electrodes, the sustain electrodes and the scan electrodes, respectively, to discharge discharge cells formed by the address electrodes, sustain electrodes and the scan electrodes.

According to the present invention, the effective reset operation is performed in the reset period in the cell having the wall charges damaged for various reasons by applying the proper or suitable voltage of Vrs in the reset period of at least one subfield, and therefore the problem of misfiring discharge in the address period caused by the loss of the wall charges is solved.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A method for driving a plasma display panel including a plurality of first electrodes and a plurality of second electrodes formed on a first substrate, and a plurality of third electrodes crossing the first electrodes and the second electrodes and formed on a second substrate, wherein discharge cells are formed by the first, second, and third electrodes, the method comprising:
in a reset period of at least one of subfields,
increasing a voltage difference between voltages applied to at least one of the second electrodes and at least one of the first electrodes from a first voltage to a second voltage and reducing the voltage difference; and
in a reset period of at least another one of the subfields,
a) applying a third voltage, which is less than the second voltage, between the at least one of the second electrodes and the at least one of the first electrodes, and
b) gradually reducing a voltage applied to the at least one of the second electrodes from a fourth voltage to a fifth voltage,
wherein the third voltage is greater than a sixth voltage corresponding to a voltage difference between voltages applied to the at least one of the first electrodes and the at least one of the second electrodes in a sustain period.

2. The method of claim 1, wherein the third voltage is less than a voltage obtained by subtracting the sixth voltage from two times a discharge firing voltage.

3. The method of claim 1, wherein the third voltage corresponds to the fourth voltage.

4. The method of claim 2, wherein the third voltage corresponds to the fourth voltage.

5. The method of claim 1, wherein, in a), the voltage applied to the at least one of the second electrodes is increased to the third voltage by a second slope which is greater than a first slope of the voltage rising from the first voltage to the second voltage applied in the at least one of the subfields.

6. The method of claim 2, wherein, in a), the voltage applied to the at least one of the second electrodes is increased to the third voltage by a second slope which is greater than a first slope of the voltage rising from the first voltage to the second voltage applied in the at least one of the subfields.

7. The method of claim 1, wherein, in a), the voltage applied to the at least one of the second electrodes is increased to the third voltage by a slope which is equal to or less than a first slope of the voltage rising from the first voltage to the second voltage applied in the at least one of the subfields.

8. The method of claim 2, wherein, in a), the voltage applied to the at least one of the second electrodes is increased to the third voltage by a slope which is equal to or less than a first slope of the voltage rising from the first voltage to the second voltage applied in the at least one of the subfields.

9. The method of claim 1, further comprising, in a reset period of at least yet another one of the subfields, applying a voltage which gradually decreases from the sixth voltage to the fifth voltage, to the at least one of the second electrodes.

10. A method for driving a plasma display panel including a plurality of first electrodes and a plurality of second electrodes formed on a first substrate, and a plurality of third electrodes crossing the first electrodes and the second electrodes and formed on a second substrate, wherein discharge cells are formed by the first, second, and third electrodes, the method comprising, when a field is divided into a plurality of subfields to be driven, and each subfield has a reset period, an address period, and a sustain period:
applying a voltage for a reset discharge to at least one of the first electrodes and at least one of the second electrodes to perform a reset operation in the reset period;
applying a voltage for an address discharge to the at least one of the first electrodes and the at least one of the third electrodes of at least one discharge cell selected from the discharge cells to perform an address operation in the address period; and
applying a voltage for a sustain discharge to the at least one of the first electrodes and the at least one of the second electrodes to perform a sustain operation in the sustain operation,
wherein, in at least one subfield of the plurality of subfields, the reset operation performs a reset-discharge for discharge cells which were sustain-discharged and some discharge cells which were not sustain-discharged in a previous one of the plurality of subfields.

11. The method of claim 10, wherein a wall charge state has been damaged after a reset operation of the previous one of the plurality of subfields in the some discharge cells which were not sustain-discharged.

12. A plasma display comprising:
a first substrate;
a plurality of first electrodes and a plurality of second electrodes formed on the first substrate in parallel;
a second substrate facing the first substrate with a gap therebetween;
a plurality of third electrodes formed on the second substrate and crossing the first electrodes and the second electrodes; and
a driving circuit for supplying a driving voltage to the first electrodes, the second electrodes, and the third electrodes to discharge the discharge cells formed by the first, second, and third electrodes,
wherein the driving circuit increases a voltage difference between voltages applied to at least one of the second electrodes and at least one of the first electrodes from a first voltage to a second voltage and reduces the voltage difference in a reset period of at least one of subfields, and applies a third voltage, which is less than the second voltage, between the at least one of the second electrodes and the at least one of the first electrodes, and reduces a voltage applied to the at least one of the second electrodes in a reset period of at least another one of the subfields, and
the third voltage is greater than a fourth voltage which is a difference between voltages applied to the at least one of the first electrodes and the at least one of the second electrodes in a sustain period.

13. The plasma display of claim 12, wherein the third voltage is less than a voltage obtained by subtracting the fourth voltage from two times a discharge firing voltage.

14. A method of driving a plasma display panel comprising a plurality of address electrodes, a plurality of scan electrodes and a plurality of sustain electrodes, during a field comprising a plurality of subfields, each of the subfields comprising a reset period, an address period and a sustain period, the method comprising:
applying a voltage which is gradually increased from a first voltage to a second voltage between at least one of the scan electrodes and at least one of the sustain electrodes during the reset period of at least one of the plurality of subfields;
applying a third voltage between the at least one of the scan electrodes and the at least one of the sustain electrodes during the reset period of at least another one of the subfields, the third voltage being lower than the second voltage and higher than a sustain voltage applied between the at least one of the scan electrodes and the at least one of the sustain electrodes during the sustain period; and
gradually reducing a voltage applied to the at least one of the scan electrodes from the third voltage or a fourth voltage, which is lower than the third voltage, to a fifth voltage during the reset period of the at least another one of the subfields.

15. The method of claim 14, wherein the voltage applied to the at least one of the scan electrodes is substantially instantaneously changed from the third voltage to the fourth voltage during the reset period of the at least another one of the subfields.

16. The method of claim 15, wherein the voltage applied to the at least one of the scan electrodes is decreased from the fourth voltage to the fifth voltage during the reset period of the at least another one of the subfields.

17. The method of claim 14, wherein the third voltage is between the sustain voltage applied between the at least one of the scan electrodes and the at least one of the sustain electrodes during the sustain period and two times a discharge firing voltage subtracted by the sustain voltage.

18. The method of claim 14, wherein a voltage applied to the at least one of the scan electrodes is gradually increased to the third voltage during the reset period of the at least another one of the subfields, and wherein a slope by which the voltage applied to the at least one of the scan electrodes is gradually increased is greater than a slope by which the first voltage is increased to the second voltage.

19. The method of claim 14, wherein a voltage applied to the at least one of the scan electrodes is gradually increased to the third voltage during the reset period of the at least another one of the subfields, and wherein a slope by which the voltage applied to the at least one of the scan electrodes is gradually increased is less than or equal to a slope by which the first voltage is increased to the second voltage.

20. The method of claim 14, further comprising applying a sixth voltage, which is higher than the fifth voltage, to the at least one of the sustain electrodes while the voltage applied to the at least one of the scan electrodes decreases from the third voltage or the fourth voltage to the fifth voltage, such that a voltage difference between the at least one of the scan electrodes and the at least one of the sustain electrodes becomes a voltage difference between the sixth voltage and the fifth voltage at the end of the reset period of the at least another one of the subfields.

21. The method of claim 14, wherein none of the subfields overlaps with another one of the subfields.
